(19) United States
(12) Patent Application Publication
(10) Pub. No.: US 2008/0313652 A1
(43) Pub. Date: Dec. 18, 2008

(54) Notifying user mode scheduler of blocking events

(75) Inventors: Matthew D. Klein, Seattle, WA (US); Paul England, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/818,627

(22) Filed: Jun. 15, 2007

(51) Int. Cl. G06F 13/00

(52) U.S. Cl. 719/318

(57) ABSTRACT

Various technologies and techniques are disclosed for detecting and handling blocking events. A user mode thread is assigned a dedicated backing thread. System calls are made on the dedicated backing thread. The kernel detects when a system call results in a blocking event. A core that the dedicated backing thread is currently running on is observed. An entry in a per process table that maps cores to a currently associated primary thread waiting to be woken is consulted. The currently associated primary thread for the core is woken with a special result code to indicate that it was woken due to the blocking system call. The primary thread is released back to the application. A user mode scheduler is notified of the blocking event so a core can continue to be utilized.

### BACKGROUND

Over time, computer hardware has become faster and more powerful. For example, computers of today can have multiple processor cores that can operate in parallel. Programmers would like for different pieces of the program to execute in parallel on these multiple processor cores to take advantage of the performance improvements that can be achieved. As part of this effort, future highly parallel systems will likely make use of user mode scheduling. This means that for a given amount of time, a program can be reasonably assured that it will maintain primary control of a particular number of cores and will be responsible for efficient scheduling of those cores.

One major problem with user mode scheduling is when a user mode execution context ends up blocking inside of the kernel due to a system call or page fault. In such scenarios, the user mode scheduler is not made aware of the blockage and cannot make subsequent use of the idle core.

### SUMMARY

Various technologies and techniques are disclosed for detecting and handling blocking events. A user mode thread is assigned a dedicated backing thread. System calls are made on the dedicated backing thread. The kernel detects when a system call results in a blocking event. A core that the dedicated backing thread is currently running on is observed. An entry in a per process table that maps cores to a currently associated primary thread waiting to be woken is consulted. The currently associated primary thread for the core is woken with a special result code to indicate that it was woken due to the blocking system call. The primary thread is released back to the application. A user mode scheduler is notified of the blocking event so a core can continue to be utilized.

In one implementation, a user mode scheduler is notified of an oversubscription of threads. The user mode scheduler is notified once a now-unblocked backing thread returns to a user mode. A user mode thread context is saved on a user mode ready-queue for later execution by a primary thread. The backing thread is returned to a runtime for a next system call.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a scheduler activations application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in normal system call execution in the absence of blocking.

FIG. 5 is a process flow diagram for one implementation of the system of FIG. 1 illustrating the stages involved in handling a blocking event on a system call.

FIG. 6 is a process flow diagram for one implementation of the system of FIG. 1 illustrating the stages involved in notifying the user mode scheduler about the oversubscription of threads.

FIG. 7 is a diagram for one implementation of the system of FIG. 1 that illustrates notifications sent when system calls on user mode portions of threads block.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that activates a thread scheduler when blockages occur, but the system also serves other purposes in addition to these. In one implementation, one or more of the techniques described herein can be implemented as features within an operating system program such as MICROSOFT® WINDOWS®, or from any other type of program or service that manages and/or executes threads.

In one implementation, a system is provided that allows a kernel to notify a user mode scheduler that a blockage has occurred. The user mode scheduler can then proceed to run parallel execution contexts while the block is being resolved, or in the case of a wait event, to explicitly cause the wait to be resolved and avoid deadlock.

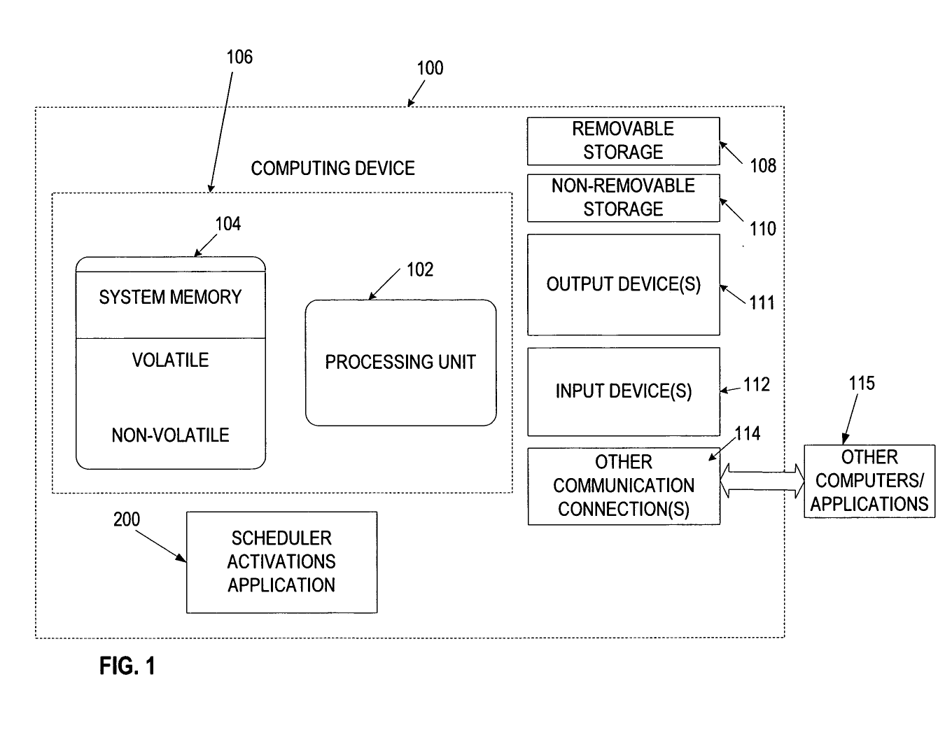

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

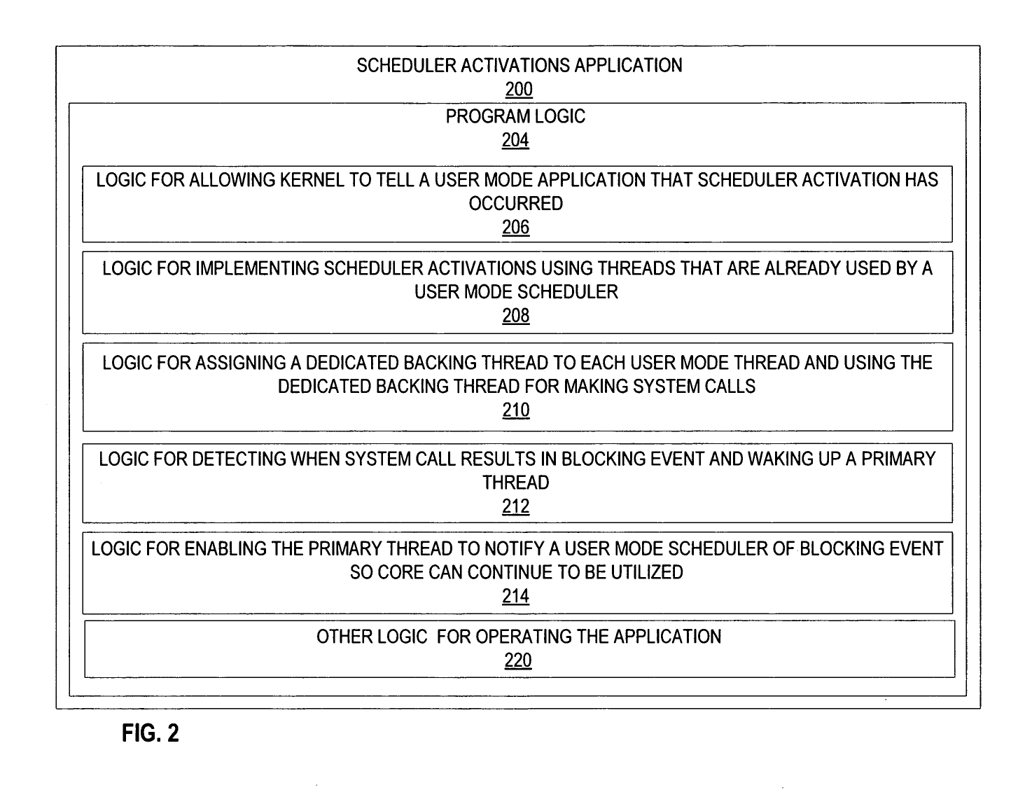

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes scheduler activations application 200. Scheduler activations application 200 will be described in further detail in FIG. 2.

Turning now to FIG. 2 with continued reference to FIG. 1, a scheduler activations application 200 operating on computing device 100 is illustrated. Scheduler activations application 200 is one of the application programs that reside on computing device 100. However, it will be understood that scheduler activations application 200 can alternatively or additionally be embodied as computer-executable instructions on one or more computers and/or in different variations than shown on FIG. 1. Alternatively or additionally, one or more parts of scheduler activations application 200 can be part of system memory 104, on other computers and/or applications 115, or other such variations as would occur to one in the computer software art.

Scheduler activations application 200 includes program logic 204, which is responsible for carrying out some or all of the techniques described herein. Program logic 204 includes logic for allowing a kernel to tell a user mode application that scheduler activations has occurred 206; logic for implementing scheduler activations using threads that already used by a user mode scheduler 208; logic for assigning a dedicated backing thread to each user mode thread and using the dedicated backing thread for making system calls 210; logic for detecting when a system call results in blocking event and waking up a primary thread 212; logic for enabling the primary thread to notify a user mode scheduler of the blocking event so the core can continue to be utilized 214; and other logic for operating the application 220. In one implementation, program logic 204 is operable to be called programmatically from another program, such as using a single call to a procedure in program logic 204.

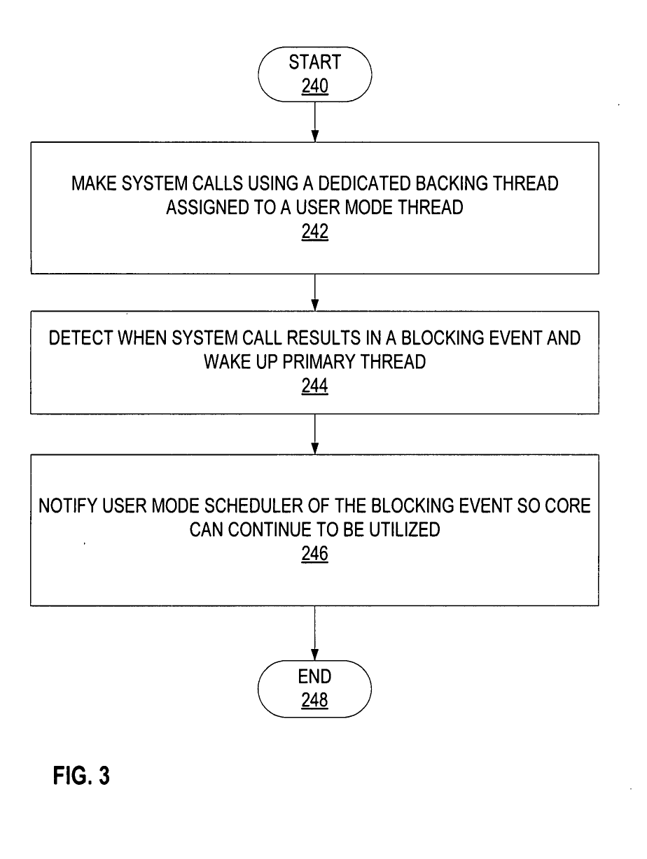

Turning now to FIGS. 3-6 with continued reference to FIGS. 1-2, the stages for implementing one or more implementations of scheduler activations application 200 are described in further detail. The term “scheduler activations” as used herein is meant to include functionality provided by a kernel that allows a new (or previously suspended) execution context to be executed on an idle core, thus allowing a user mode scheduler to continue to use the core subsequent to an event that caused the core to become idle. FIG. 3 is a high level process flow diagram for scheduler activations application 200. In one form, the process of FIG. 3 is at least partially implemented in the operating logic of computing device 100. The system allows regular kernel threads (composed of kernel and user portions) to become special affinitized-threads called primary threads whose kernel threads are used as an execution context for user mode threads. The process begins at start point 240 with user mode system calls being made using a dedicated backing thread assigned to a respective user mode thread (stage 242). The system detects when a system call results in a blocking event and wakes the primary thread (stage 244). The primary thread notifies the user mode scheduler of the blocking event so that the core can continue to be utilized (stage 246). The process ends at end point 248.

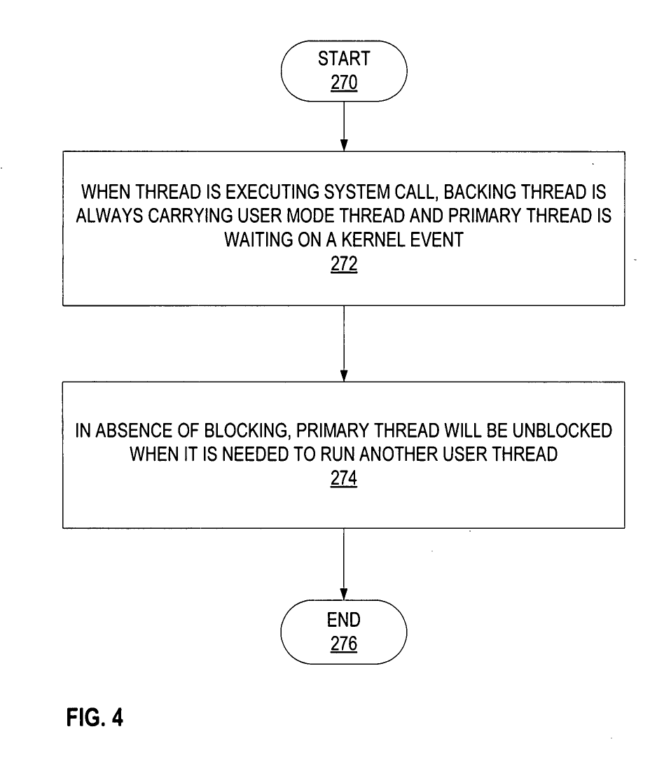

FIG. 4 illustrates one implementation of the stages involved in a normal system call execution in the absence of blocking. In one form, the process of FIG. 4 is at least partially implemented in the operating logic of computing device 100. The process begins at start point 270. In one implementation, when the thread is executing a system call, the backing thread always carries the user mode thread and the primary thread waits on a kernel event (stag 272). In absence of blocking, the primary thread will be unblocked when it is needed to run another user thread (stage 274). The process ends at end point 276.

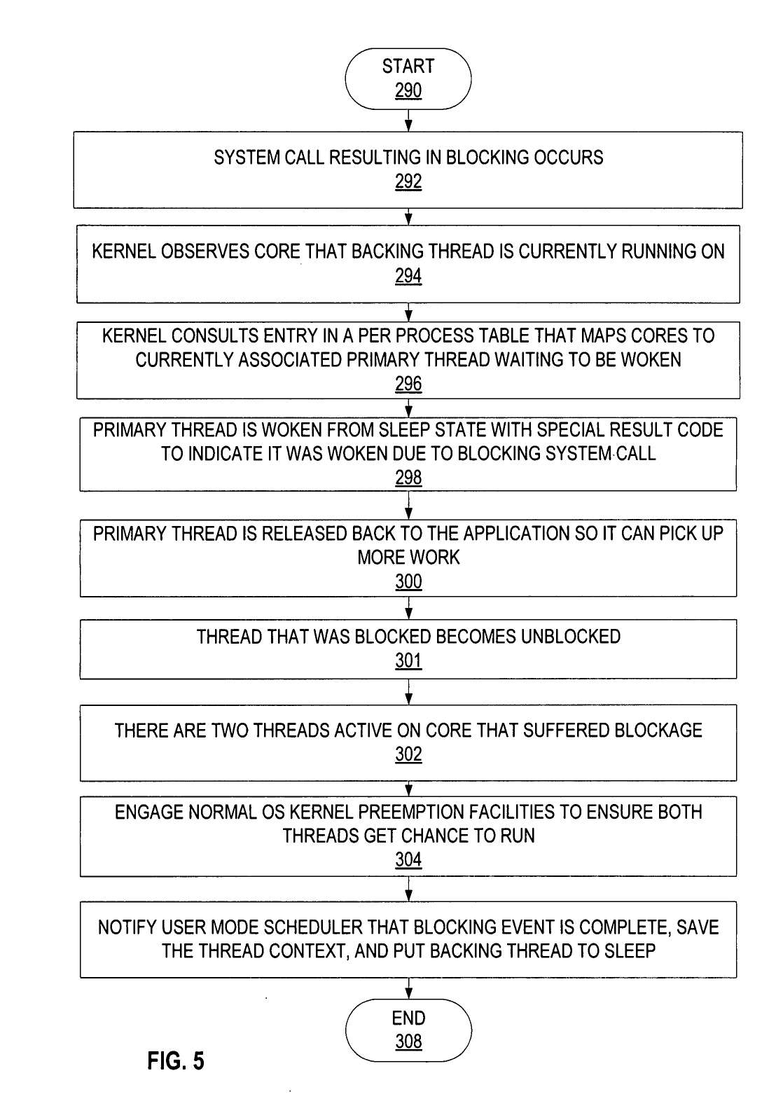

FIG. 5 illustrates one implementation of the stages involved in handling a blocking event on a system call. In one form, the process of FIG. 5 is at least partially implemented in the operating logic of computing device 100. The process begins at start point 290 with a system call made by a user mode thread executing on a dedicated backing thread causing a blocking event (stage 292). The kernel observes the core that a backing thread is currently running on (stage 294). The kernel consults the entry in a per process table that maps the cores to currently associated primary thread waiting to be woken (stage 296). The primary thread is woken from sleep state with a special result code to indicate it was woken due to a blocking system call (stage 298). The primary thread is released back to the application so it can pick up more work (stage 300). The thread that was blocked becomes unblocked (stage 300). At this point, there are now two threads active on the core that suffered blockage: the dedicated backing thread and the primary thread (stage 302). Normal operating system kernel preemption facilities are engaged to ensure both threads and the user mode threads they carry get a chance to run (stage 304). The system notifies the user mode scheduler that the blocking event is complete, saves the thread context, and puts the backing thread to sleep (stage 306). The process ends at end point 308.

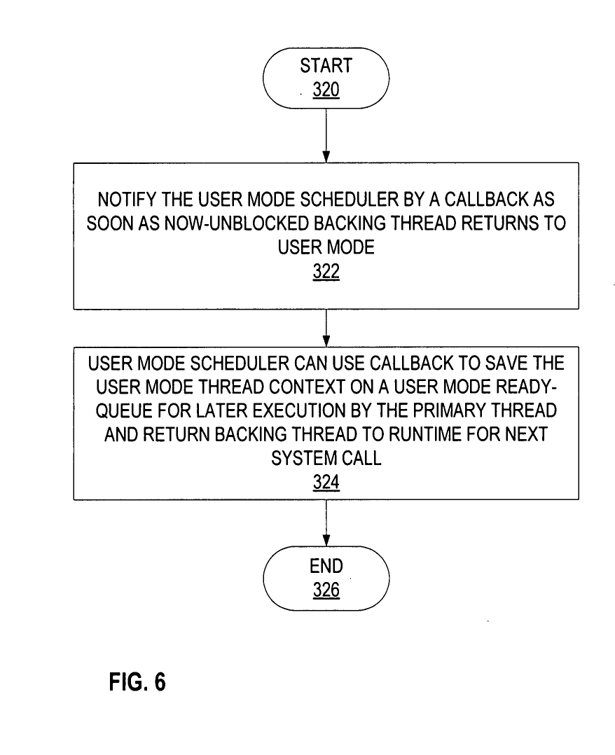

FIG. 6 illustrates one implementation of the stages involved in notifying the user mode scheduler about the oversubscription of threads. In one form, the process of FIG. 6 is at least partially implemented in the operating logic of computing device 100. The process begins at start point 320 with the system notifying the user mode scheduler by a callback as soon as the now-unblocked backing thread returns to the user mode (stage 322). The user mode scheduler can use the callback to save the user mode thread context on a user mode ready-queue for later execution by the primary thread and return the backing thread to the runtime for the next system call (stage 324). The process ends at end point 326.

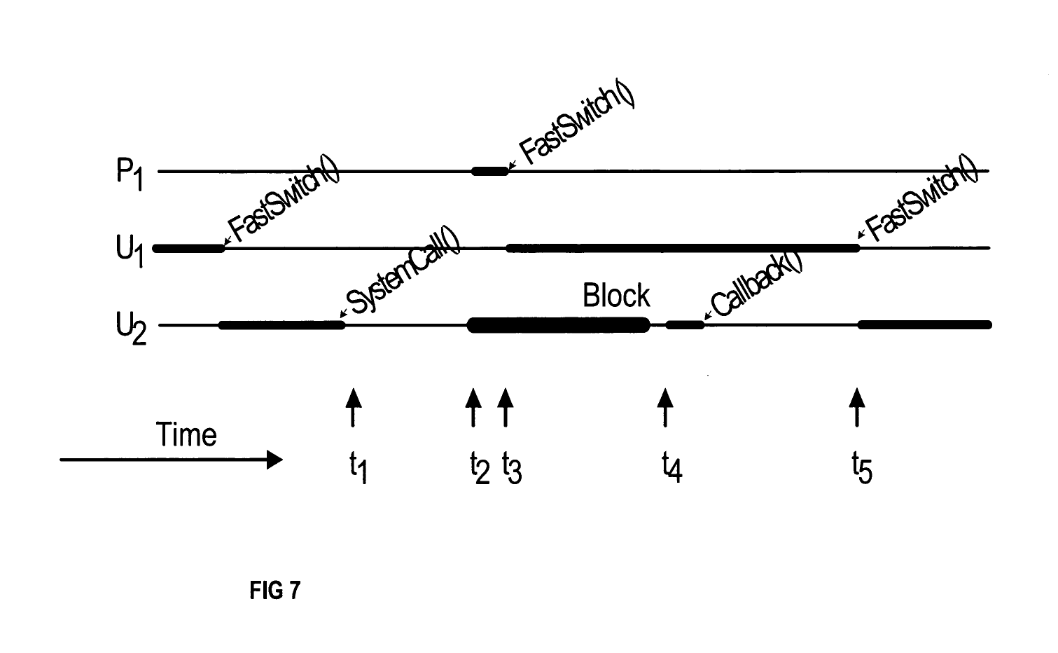

FIG. 7 is a diagram 500 for one implementation of the system of FIG. 1 that illustrates notifications sent when system calls on user mode portions of threads block. The diagram only illustrates the user mode part of the thread. In the example shown, P is the primary thread, and U1 and U2 are two user scheduled threads. At t1 the application makes a system call which runs for a while and blocks at time t2. At t2 the primary thread is released back to the application. In one implementation, the primary thread will typically call a routine to switch to another user mode thread. At t4 the system call unblocks and the application has two runnable threads that the kernel scheduler will dispatch using its normal algorithms. When the just-unblocked thread returns to user mode it will call back into the application/user-mode scheduler. Generally the application will not want more than one runnable thread on the core and will place the user-thread on a ready-queue. At t5 the user-scheduler picks up the waiting work and continues to run it.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
assign a dedicated backing thread to a user mode thread;
make system calls using the dedicated backing thread;
detect when a particular system call results in a blocking event;
wake up a primary thread; and
allow the primary thread to notify a user mode scheduler of the blocking event so a core can continue to be utilized.

2. The computer-readable medium of claim 1, wherein the detecting step is further operable to observe the core that the dedicated backing thread is currently running on.

3. The computer-readable medium of claim 2, wherein the detecting step is further operable to consult an entry in a per process table that maps cores to the primary thread waiting to be woken.

4. The computer-readable medium of claim 3, wherein the waking step is further operable to wake the primary thread with a special result code to indicate that the primary thread was woken due to the blocking system call.

5. The computer-readable medium of claim 4, wherein the primary thread is released back to an application.

6. The computer-readable medium of claim 5, wherein the user mode thread running on the dedicated backing thread that was blocked becomes unblocked.

7. The computer-readable medium of claim 6, wherein normal operating system kernel preemption facilities are engaged to ensure both the primary thread and the dedicated backing thread, and the user threads that the primary thread and the dedicated backing thread carry, get a chance to run.

8. The computer-readable medium of claim 1, wherein the notifying stage is further operable to save a thread context.

9. The computer-readable medium of claim 8, wherein the notifying stage is further operable to put the dedicated backing thread to sleep.

10. A method for handling a blocking event on a system call comprising the steps of:
detecting that a system call made by a user mode thread executing on a dedicated backing thread has caused a blocking event in an application;
observing a core that the backing thread is currently running on;
consulting an entry in a per process table that maps cores to a currently associated primary thread waiting to be woken;
waking the currently associated primary thread for the core with a special result code to indicate that the currently associated primary thread was woken due to the blocking system call; and
releasing the primary thread back to the application.

11. The method of claim 10, wherein at some point subsequent to releasing the primary thread back to the application, the backing thread that was blocked becomes unblocked.

12. The method of claim 11, wherein upon the backing thread becoming unblocked, the primary thread and the backing thread are both active on the core that suffered blockage.

13. The method of claim 12, wherein normal operating system kernel preemption facilities are engaged to ensure the primary thread and the backing thread both get a chance to run.

14. The method of claim 10, further comprising:
notifying a user mode scheduler that the blocking is complete.

15. The method of claim 14, further comprising:
saving a thread context of the user mode thread executing on a dedicated backing thread.

16. The method of claim 15, further comprising:
putting the backing thread to sleep.

17. A computer-readable medium having computer-executable instructions for causing a computer to perform the steps recited in claim 10.

18. A method for notifying a user mode scheduler regarding an oversubscription of threads comprising the steps of:
notifying a user mode scheduler once a now-unblocked backing thread returns to a user mode;
saving a user mode thread context on a user mode ready-queue for later execution by a primary thread; and
returning the backing thread to a runtime for a next system call.

19. The method of claim 18, wherein the notifying the user mode scheduler is performed using a callback.

20. A computer-readable medium having computer-executable instructions for causing a computer to perform the steps recited in claim 18.
